(19) United States
(12) Patent Application Publication
(10) Pub. No.: US 2004/0017581 A1
(43) Pub. Date: Jan. 29, 2004

(54) Apparatus and method for cancellation by recipient of image signal retransmission

(76) Inventors: Angelica Quintana, Fort Collins, CO (US); Theodore B. Ziemkowski, Loveland, CO (US)

Correspondence Address: HEWLETT PACKARD COMPANY, Intellectual Property Administration, P. O. Box 272400, Fort Collins, CO, 80527-2400, US

(21) Appl. No.: 10/201,432

(22) Filed: Jul. 23, 2002

(51) Int. Cl. G06K 1/00; G06F 15/00; H04N 1/00

(52) U.S. Cl. 358/1.15; 358/402

(57) ABSTRACT

An apparatus and method for cancellation of image signal retransmission by recipient. In one embodiment of the invention, a source device capable of cancelling image signal retransmission from a source device to a target device following an unsuccessful transmission attempt and on receipt of instruction from the target device comprises a first circuit and a second circuit. The first circuit is capable of enabling connection between the source device and the target device via a communication system. When the source device unsuccessfully transmits the image signal to the target device, the first circuit initiates retransmission of the image signal from the source device to the target device at a time following an initial transmission unless otherwise inhibited. The second circuit is communicatively connected to the first circuit, and the second circuit is capable of receiving a control signal from the target device when the source device is connected to the target device. When the control signal meets preselected criteria, the second circuit is capable of inhibiting retransmission of the image signal by the source device.

### FIELD OF THE INVENTION

The present invention relates generally to the transmission of image signals in communication systems and, more particularly, to an apparatus and method for cancellation of the transmission of image signals.

### BACKGROUND OF THE INVENTION

Facsimile machines and computers connected to communication systems, as for example telephone systems and computer networks, are often used to conveniently send copies of documents and photographs from one station to another. Should the equipment at the receiving station be occupied with other tasks and thus unavailable to receive the facsimile transmission, the sending station is alerted to this situation. The sending station typically has the ability to attempt at a later time to resend the facsimile transmission. Such retransmission attempts may be repeated a selected number of times if the retransmission continues to be unsuccessful.

However, it can happen that the receiving station has been misidentified and is not equipped to receive these copies. In such case, attempts at retransmission results in wasted resources for the sending station, the receiving station, and the communication system. In addition, for telephone systems the receiving telephone user is subjected to numerous irritating, erroneous calls which either he may choose to answer or to ignore. If he ignores one or more of these calls, he does so at the risk of missing other calls. In addition, if an answering machine is attached to the receiving station and takes control, the answering machine will record a useless message each time it receives such a call. And, unless closely monitored, the sending station user may not realize that this particular receiving station is not appropriately equipped for receiving facsimiles and may initiate future attempts adding to the misuse of resources and to the receiving station user's frustration.

### SUMMARY OF THE INVENTION

In one embodiment of the invention, a source device capable of cancelling image signal retransmission from a source device to a target device following an unsuccessful transmission attempt and on receipt of instruction from the target device comprises a first circuit and a second circuit. The first circuit is capable of enabling connection between the source device and the target device via a communication system. When the source device unsuccessfully transmits the image signal to the target device, the first circuit initiates retransmission of the image signal from the source device to the target device at a time following an initial transmission unless otherwise inhibited. The second circuit is communicatively connected to the first circuit, and the second circuit is capable of receiving a control signal from the target device when the source device is connected to the target device. When the control signal meets preselected criteria, the second circuit is capable of inhibiting retransmission of the image signal by the source device.

In another embodiment, a software program on a storage medium that embodies instructions executable by a processor comprises logic for receiving, at a source device, a control signal transmitted from a target device, and logic for inhibiting retransmission of an image signal from the source device to the target device, when the control signal meets preselected criteria.

And in yet another embodiment, a method is disclosed for cancellation of image signal retransmission from a source device to a target device. A control signal transmitted from the target device is received at the source device, and when the control signal meets preselected criteria, retransmission of the image signal from the source device to the target device is inhibited.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The accompanying drawings provide visual representations which will be used to more fully describe the invention and can be used by those skilled in the art to better understand it and its inherent advantages. In these drawings, like reference numerals identify corresponding elements.

FIG. 1 is a block diagram of a system for transmission of an image signal as described in various representative embodiments consistent with the teachings of the invention.

FIG. 2 is another block diagram of the system of FIG. 1.

FIG. 3 is still another block diagram of the system of FIG. 1.

FIG. 4 is a drawing of a flow chart of a method for recipient cancellation of image signal retransmission as described in various representative embodiments consistent with the teachings of the invention.

### DETAILED DESCRIPTION OF THE PREFERRED EMBODIMENTS

As shown in the drawings for purposes of illustration, embodiments of the present invention comprise novel means for eliminating retransmission attempts of image signals from a source station, as for example a facsimile (FAX) machine, to a receiving or target station which is not equipped to receive such a transmission. Previously, if a transmission were unsuccessful, the source station alone determined whether it would attempt to retransmit the image.

In the following detailed description and in the several figures of the drawings, like elements are identified with like reference numerals.

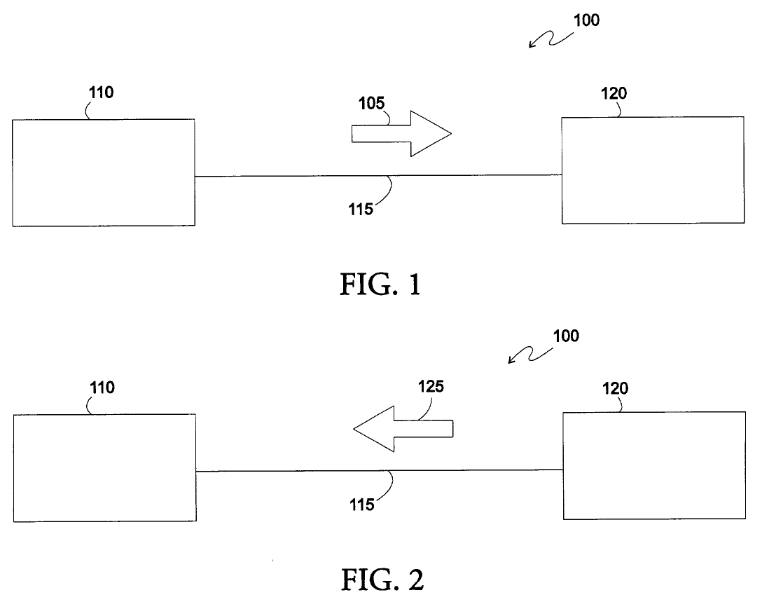

FIG. 1 is a block diagram of a system 100 for transmission of an image signal 105 as described in various representative embodiments consistent with the teachings of the invention. In FIG. 1, a source device 110 transmits the image signal 105 via a communication system 115 to a target device 120. The source device 110 could be, for example, a facsimile (FAX) machine 110, a multi-function device 110, a computer 110, or other transmission device 110. The communication system 115 could be, for example, a telephone system 115 or a computer network 115. Further, the communication system 115 can employ a variety of transmission technologies including those which are both hard-wired and those which employ a variety of paths that are selectable at the time of transmission, as well as those which are wired and wireless. Wireless systems can include those that utilize satellites, as well as land based systems. The target device 120 could be, for example, another facsimile machine 120, a computer 120, a multi-function device 120, a telephone 120, a telephone answering machine 120, or other receiving device 120. Image signals 105 could be, for example, facsimiles 105, digital representations 105 of images, or the like.

FIG. 2 is another block diagram of the system 100 of FIG. 1. In FIG. 2, the target device 120 is appropriately equipped for receiving the transmission of the image signal 105. The target device 120 will notify the source device 110 that it has received the image signal 105 transmission via a confirmation signal 125. For this example also, the target device 120 is typically a FAX machine 120, a multifunction device 120, or computer 120.

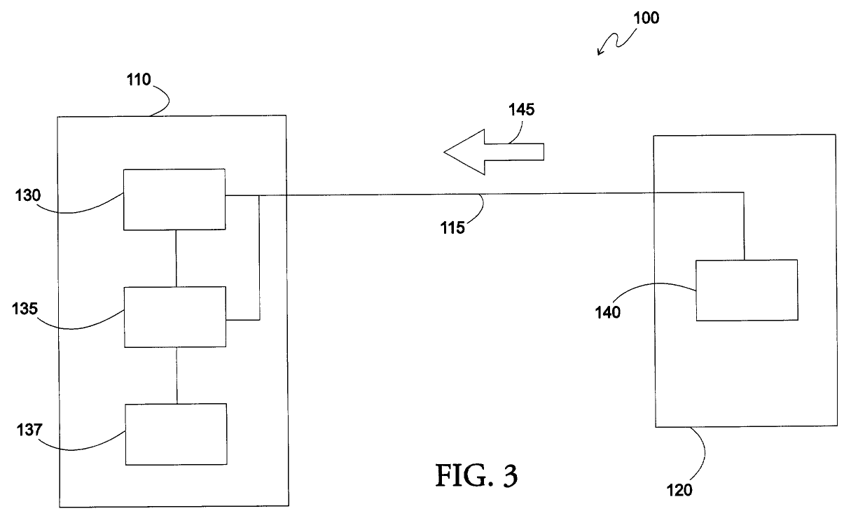

FIG. 3 is still another block diagram of the system 100 of FIG. 1. In FIG. 3, the source device 110 comprises a first circuit 130, a second circuit 135, and a third circuit 137. The first circuit 130 functions to enable connection of the source device 110 to the target device 120, as well as transmission of the image signal 105, and then any subsequent reconnecting and retransmission at a time following the initial transmission. The target device 120 comprises a signal generation circuit 140. The target device 120 in the example of FIG. 3 is not equipped, for whatever reason, to receive the image signal 105 transmitted by the source device 110. After a connection has been established between the source and target devices 110,120 and before that connection is broken, the signal generation circuit 140 generates a control signal 145 that the target device 120 sends to the second circuit 135 in the source device 110. If the source device 110 receives the appropriate control signal 145, the second circuit 135 inhibits function of the first circuit 130 for any subsequent reconnecting between the source and target devices 110,120 and/or retransmission of the image signal 105.

The control signal 145 can be generated and sent to the source device 110 automatically by the target device 120 or manually by the target device 120 user. In a manual embodiment, the target device 120 user pushes selected keys on a push-button telephone. The control signal 145 could then be binary formatted signal 145 or tone(s) from the push-button telephone. In an alternative manual embodiment, the control signal 145 is, for example, the human voice 145 of the target device 120 user after he or she lifts the telephone handset of the target device 120. In an automatic embodiment, the control signal 145 is the recorded human voice 145 of a telephone answering machine 120 after the source device 110 connects to it. And in another automatic embodiment, electronics in the target device 120 generates the control signal 145. In any such embodiment, it becomes known to the source device 110 that the target device 120 is not equipped to receive the image signal 105. Both manual and automatic embodiments can be combined in a single system.

In yet another representative embodiment, the third circuit 137 of the source device 110 identifies the communication system 115 address of the target device 120 as one not equipped to receive image signals 105. The source device 110 user can then identify that address as one to which he will not attempt to send image signals 105 in the future. This address is then removed from a list of target devices 435 to which the source device 110 transmits image data 105. Alternatively, the source device 110 could maintain a list of target device 120 addresses to which it will not transmit image data 105. Addition of target device 120 address to either list could be performed either automatically by the source device 110 or manually by the source device 110 user. In an example, the communication system 115 address is the phone number of the telephone at the target device 120 location. The third circuit 137 could perform a variety of operations including, but not limited to, displaying the address, storing the address, and automatically inhibiting the source device 110 from sending future messages to the target device 120.

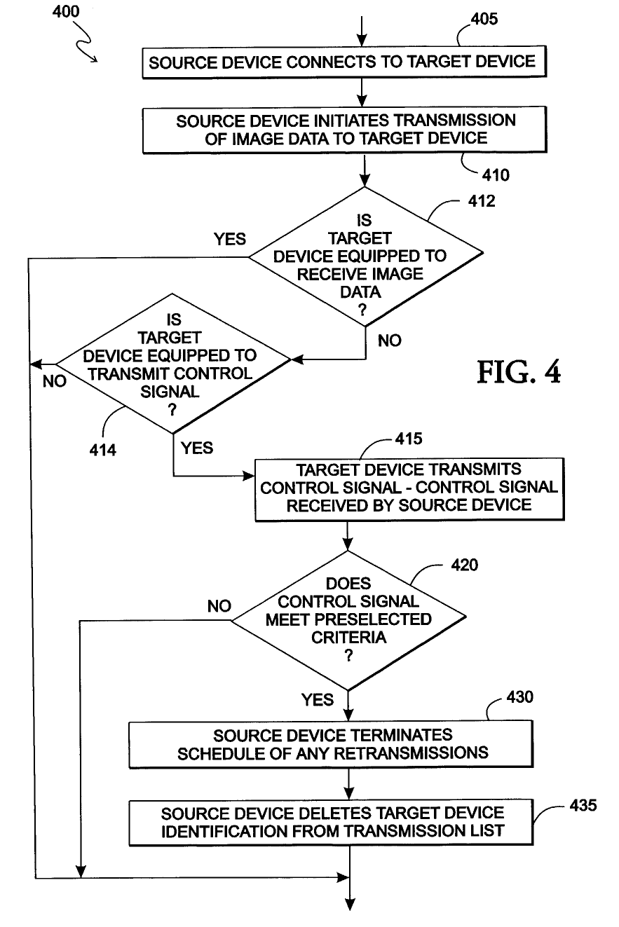

FIG. 4 is a drawing of a flow chart 400 of a method for recipient cancellation of image signal 105 retransmission as described in various representative embodiments consistent with the teachings of the invention.

In block 405, the source device 110 makes connection to the target device 120. Block 405 then transfers control to block 410.

In block 410, the source device 110 initiates transmission of image data 105 to the target device 120. Block 410 then transfers control to block 412.

When the target device 120 is equipped to receive image data 105, block 412 terminates the process. Otherwise, block 412 transfers control to block 414.

When the target device 120 is equipped to transmit the control signal 145, block 414 transfers control to block 415. Otherwise, block 414 terminates the process. Note that if the control signal 145 expected by the source device 110 is the human voice and if the human voice is transmitted upon connection between the source device 110 and the target device 120, the target device 120 is preferably considered to be equipped to transmit the control signal 145. As discussed above, the appropriate control signal 145 inhibits any subsequent reconnecting between the source and target devices 110,120 and/or retransmission of the image signal 105. Also as discussed above, the control signal 145 can be generated and sent to the source device 110 automatically and/or manually by the target device 120 user, as for example by pushing selected keys on a push-button telephone. The control signal 145 could then be binary formatted signal 145 or tone(s) from the push-button telephone. In the alternative embodiment just discussed, the control signal 145 is, for example, the human voice 145 of the target device 120 user after he or she lifts the telephone handset of the target device 120, or the control signal 145 is the recorded human voice 145 of a telephone answering machine 120 after the source device 110 connects to it. In either such embodiment, the target device is equipped to transmit the control signal 145 by which it becomes known to the source device 110 that the target device 120 is not equipped to receive the image signal 105.

In block 415, the target device 120 transmits the control signal 145 to the source device 110, and the control signal 145 is subsequently received by the source device 110. Block 415 then transfers control to block 420.

When the control signal 145 meets preselected criteria, which could be, for example, a preselected sequence of bits or the human voice, block 420 transfers control to block 430. Otherwise, block 420 terminates the process.

In block 430, the source device 110 deletes the schedule of any retransmission to the target device 120. Block 430 then transfers control to block 435.

In block 435, the source device 110, as a preferable option, deletes the target device 120 identification from its list of target devices 435 to which it transmits image data 105. Block 435 then terminates the process.

The system 100 for cancellation by the target device 120 of image signal 105 retransmission from the source device 110 may be implemented as a combination of hardware and software components. Moreover, the functionality required for implementation may be stored as an application on a program storage medium. The term “program storage medium” is broadly defined herein to include any kind of computer-related memory such as, but not limited to, floppy disks, conventional hard disks, DVDs, CD-ROMs, Flash ROMs, nonvolatile ROM, RAM, etc. now known or later developed which would be generally readable by a processor.

Embodiments of the present invention provide means by which the recipient of an image signal transmission can cancel subsequent attempts at retransmission thereby reducing resource consumption and reducing the frustration of the receiving station user.

What is claimed is:

1. A source device capable of cancelling image signal retransmission from a source device to a target device following an unsuccessful transmission attempt and on receipt of instruction from the target device, which comprises:
a first circuit capable of enabling connection between the source device and the target device via a communication system, wherein when the source device unsuccessfully transmits the image signal to the target device, the first circuit initiates retransmission of the image signal from the source device to the target device at a time following an initial transmission unless otherwise inhibited; and
a second circuit communicatively connected to the first circuit, wherein the second circuit is capable of receiving a control signal from the target device when the source device is connected to the target device, and wherein when the control signal meets preselected criteria, the second circuit is capable of inhibiting retransmission of the image signal by the source device.

2. The source device as recited in claim 1, wherein the source device is selected from the group consisting of a facsimile machine, a multifunction device, and a computer.

3. The source device as recited in claim 1, wherein the communication system is selected from the group consisting of a telephone system and a computer network.

4. The source device as recited in claim 1, wherein the target device is selected from the group consisting of a telephone, a telephone answering machine, and a computer.

5. The source device as recited in claim 1, wherein the image signal is a facsimile.

6. The source device as recited in claim 1, wherein the image signal is a digital representation of an image.

7. The source device as recited in claim 1, wherein the control signal is selected from the group consisting of a binary formatted signal, a tone, a series of tones, and a human voice.

8. The source device as recited in claim 1, further comprising a third circuit, wherein the third circuit is capable of identifying the communication system address of the target device.

9. The source device as recited in claim 1, wherein the target device is a telephone and the communication system address is the telephone number of the target device.

10. A software program on a storage medium embodying instructions executable by a processor, comprising:
at a source device, logic for receiving a control signal transmitted from a target device; and
when the control signal meets preselected criteria, logic for inhibiting retransmission of an image signal from the source device to the target device.

11. The software program as recited in claim 10, wherein the source device is selected from the group consisting of a facsimile machine, a multifunction device, and a computer.

12. The software program medium as recited in claim 10, wherein the communication system is selected from the group consisting of a telephone system and a computer network.

13. The software program as recited in claim 10, wherein the target device is selected from the group consisting of a telephone, a telephone answering machine, and a computer.

14. The software program as recited in claim 10, wherein the image signal is a facsimile.

15. The software program as recited in claim 10, wherein the image signal is a digital representation of an image.

16. The software program as recited in claim 10, wherein the control signal is selected from the group consisting of a binary formatted signal, at least one tone, and a human voice.

17. The software program as recited in claim 10, further comprising, logic for removing target device identification from a transmission list on the source device.

18. The software program as recited in claim 17, wherein the target device identification is the telephone number of the target device.

19. A method for cancellation of image signal retransmission from a source device to a target device, the method comprising:
at the source device, receiving a control signal transmitted from the target device; and
when the control signal meets preselected criteria, inhibiting retransmission of the image signal from the source device to the target device.

20. The method as recited in claim 19, wherein the control signal is selected from the group consisting of a binary formatted signal, at least one tone, and a human voice.

21. The method as recited in claim 19, further comprising, removing target device identification from a transmission list on the source device.
